(19) United States
(12) Patent Application Publication
(10) Pub. No.: US 2005/0253775 A1
(43) Pub. Date: Nov. 17, 2005

(54) Multi-screen laptop system

(76) Inventor: Gordon A. Stewart, Honolulu, HI (US)

Correspondence Address: Michael S. Neustel;Suite No. 4, 2534 South University Drive, Fargo, ND, 58103, US

(21) Appl. No.: 11/127,880

(22) Filed: May 12, 2005

Related U.S. Application Data
(60) Provisional application No. 60/571,571, filed on May 12, 2004.
(60) Provisional application No. 60/604,850, filed on Aug. 25, 2004.

(51) Int. Cl. G09G 5/00

(52) U.S. Cl. 345/1.1

(57) ABSTRACT

A multi-screen laptop system for providing increased laptop functionality and productivity. The multi-screen laptop system includes a laptop having a first display and a second display movably connected to one another. The first display is pivotally attached to the second display for allowing the user to view either the first display by itself or both the first display and the second display.

### CROSS REFERENCE TO RELATED APPLICATIONS

I hereby claim benefit under Title 35, United States Code, Section 119(e) of U.S. provisional patent application Ser. No. 60/571,571 filed May 12, 2004 and Ser. No. 60/604,850 filed Aug. 25, 2004. The 60/571,571 and 60/604,850 applications are currently pending. The 60/571,571 and 60/604,850 applications are hereby incorporated by reference into this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to display screens for laptop computers and more specifically it relates to a multi-screen laptop system for providing increased laptop functionality and productivity.

2. Description of the Related Art

Any discussion of the prior art throughout the specification should in no way be considered as an admission that such prior art is widely known or forms part of common general knowledge in the field.

Conventional laptops include only a single display to view the program being operated by the user. Because of their limited size, the utilization of a plurality of software programs can be difficult since the user can typically only keep one program “active” while the remaining programs are “hidden” behind the active program. Some manufacturers have attempted to make a single display for a laptop that is larger to help solve this problem, however a single display simply becomes too large and cumbersome to utilize without providing the width required to operate multiple software programs side-by-side.

While conventional laptops may be suitable for the particular purpose to which they address, they are not as suitable for providing increased laptop functionality and productivity. Conventional laptop displays are typically not large enough to allow for the viewing and operation of multiple programs.

Various hardware and software enable the connection of a second external monitor to a laptop to provide improved viewing (e.g. the DUALVIEW feature of WINDOWS XP). This requires the usage of a video card capable of handling two monitors (e.g. NVIEW, GEFORCE 4MX 440 manufactured by NVIDIA CORPORATION). Video cards capable of handling multiple monitors typically have two modes. The first mode is a “clone” mode where the monitors display the identical image. The second mode is a “horizontal” mode whereby the multiple screens may act as a single large screen in a horizontal manner thus allowing for one program to be displayed on a first display and a second program to be displayed on a second display. Unfortunately, the second external monitor cannot be easily transported with the laptop and requires a separate support making it relatively bulky and cumbersome to utilize.

In these respects, the multi-screen laptop system according to the present invention substantially departs from the conventional concepts and designs of the prior art, and in so doing provides an apparatus primarily developed for the purpose of providing increased laptop functionality and productivity.

### BRIEF SUMMARY OF THE INVENTION

In view of the foregoing disadvantages inherent in the known types of laptop displays now present in the prior art, the present invention provides a new multi-screen laptop system construction wherein the same can be utilized for providing increased laptop functionality and productivity.

The general purpose of the present invention, which will be described subsequently in greater detail, is to provide a new multi-screen laptop system that has many of the advantages of the laptop displays mentioned heretofore and many novel features that result in a new multi-screen laptop system which is not anticipated, rendered obvious, suggested, or even implied by any of the prior art laptop displays, either alone or in any combination thereof.

To attain this, the present invention generally comprises a laptop having a first display and a second display movably connected to one another. The first display is pivotally attached to the second display for allowing the user to view either the first display by itself or both the first display and the second display.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a multi-screen laptop system that will overcome the shortcomings of the prior art devices.

A second object is to provide a multi-screen laptop system for providing increased laptop functionality and productivity.

Another object is to provide a multi-screen laptop system that can be utilized on various types of laptops.

An additional object is to provide a multi-screen laptop system that allows a user to operate multiple programs without sacrificing viewing quality.

A further object is to provide a multi-screen laptop system that expands the display of a laptop computer.

Another object is to provide a multi-screen laptop system that transitions to a compact storage structure when not in use.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the present invention with the first display fully extended allowing for viewing of the first display and a second display simultaneously.

FIG. 2 is a cross sectional view taken along line 2-2 of FIG. 1.

FIG. 3a is an upper perspective view of the present invention with the first display partially rotated along its horizontal pivot axis.

FIG. 3b is an upper perspective view of the present invention with the first display fully rotated along its horizontal pivot axis.

FIG. 3c is an upper perspective view of the present invention with the first display partially rotated along its vertical pivot axis.

FIG. 3d is an upper perspective view of the present invention with the first display fully rotated along its vertical pivot axis into a position in front of the second display.

FIG. 4a is an upper perspective view of a first alternative embodiment illustrating the first display and the second display slidably positioned within a rear support.

FIG. 4b is an upper perspective view of the first alternative embodiment illustrating the first display and the second display partially extended from the rear support.

FIG. 4c is an upper perspective view of the first alternative embodiment illustrating the first display and the second display fully extended from the rear support.

FIG. 5a is a front view of the first alternative embodiment illustrating the first display positioned in front of the second display.

FIG. 5b is a front view of the first alternative embodiment illustrating the first display and the second display partially extended from the rear support.

FIG. 5c is a front view of the first alternative embodiment illustrating the first display and the second display fully extended from the rear support.

FIG. 6a is an upper perspective view of a second alternative embodiment with a second display positioned within a first display.

FIG. 6b is an upper perspective view of the second alternative embodiment with the second display partially extended from within the first display.

FIG. 6c is an upper perspective view of the second alternative embodiment with the second display fully extended from within the first display.

FIG. 7 is an upper perspective view of a third alternative embodiment with a third display extended from the first display.

FIG. 8a is a front view of the third alternative embodiment with the second display partially extended from the first display.

FIG. 8b is a front view of the third alternative embodiment with the second display and the third display partially extended from the first display.

FIG. 8c is a front view of the third alternative embodiment with the second display and the third display fully extended from the first display.

FIG. 9 is a block diagram illustrating connection of the video card with the first display, the second display and the third display.

### DETAILED DESCRIPTION OF THE INVENTION

A. Overview

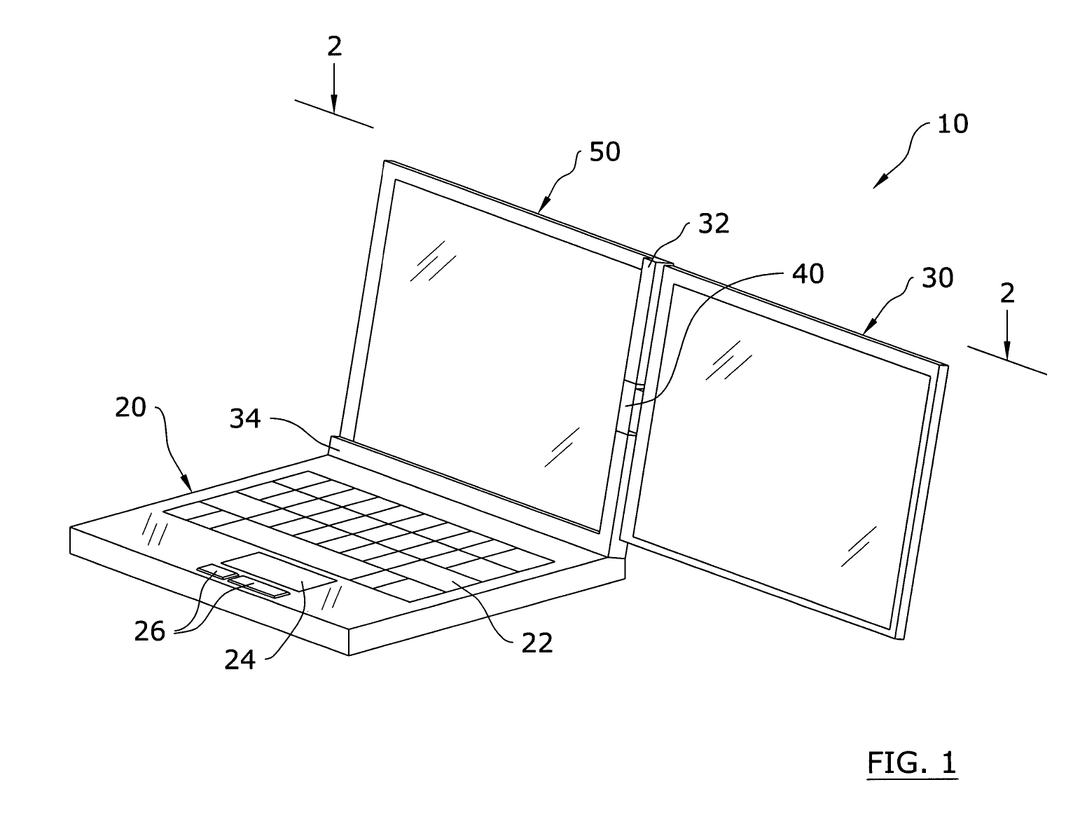

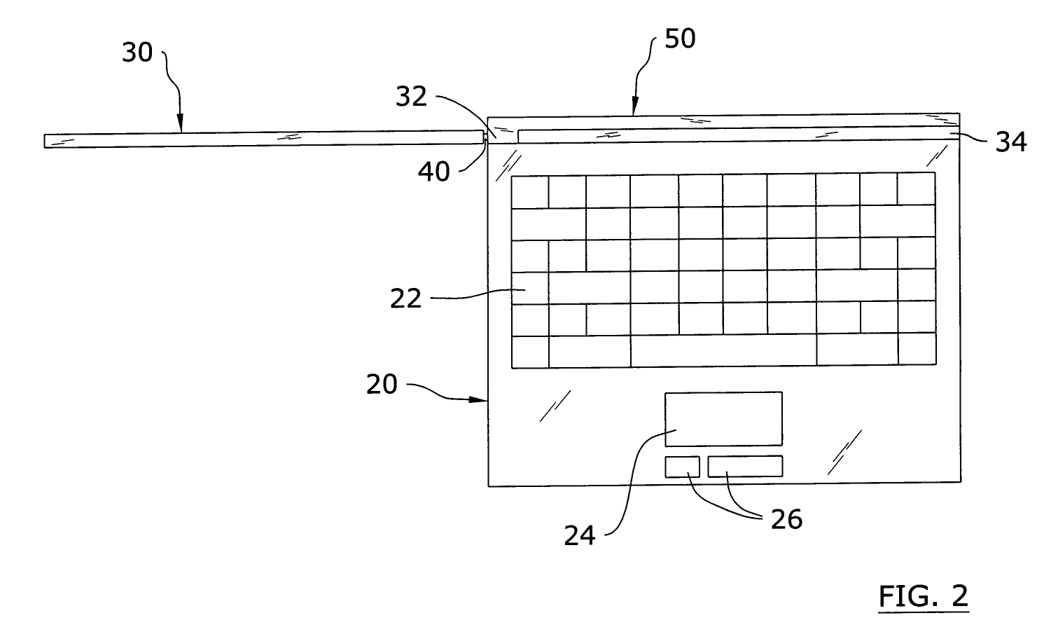

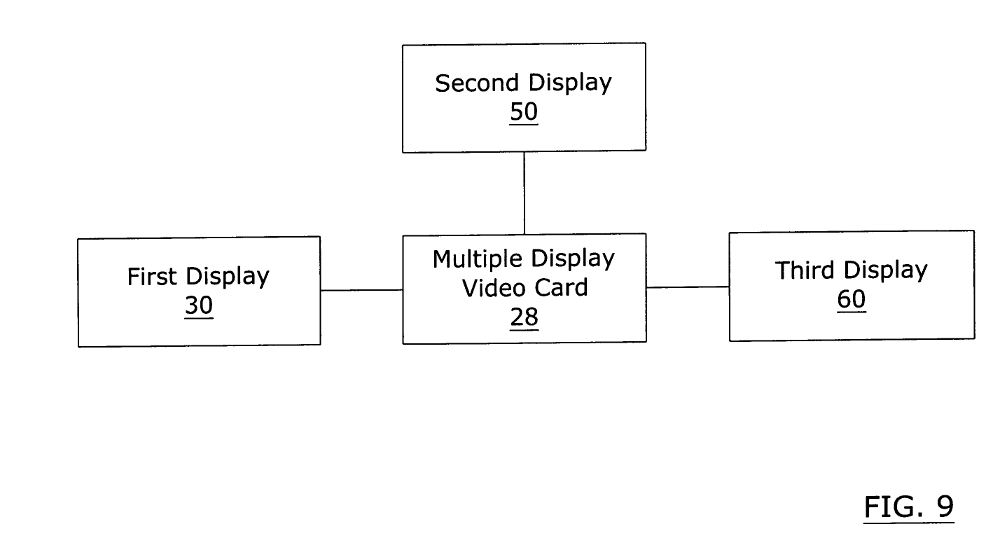

Turning now descriptively to the drawings, in which similar reference characters denote similar elements throughout the several views, FIGS. 1 through 9 illustrate a multi-screen laptop system 10, which comprises a laptop 20 having a first display 30 and a second display 50 movably connected to one another. The first display 30 is pivotally attached to the second display 50 for allowing the user to view either the first display 30 by itself or both the first display 30 and the second display 50.

B. Laptop

FIGS. 1 through 8c illustrate an exemplary laptop 20 having a first display 30, a keypad 22, a mouse pad 24 and various control buttons 26 suitable for usage with the present invention. It can be appreciated that the present invention should not be limited to the laptop 20 illustrated in the attached figures. In addition, the first display 30 may be comprised of a stand-alone monitor that is not attached to a laptop 20.

The laptop 20 further preferably includes hardware (e.g. video card 28) and/or software (e.g. DUALVIEW within MICROSOFT® XP) capable of providing a “clone” mode and a “horizontal” mode for use with multiple monitors. One or more video cards 28 may be utilized to generate the horizontal view among two or more monitors as is well known in the art. The first display 30, the second display 50 and the third display 60 are electrically connected to the laptop 20 thereby receiving the video signal in “horizontal” mode. It is preferable that the horizontal mode is entered into only if the second display 50 and/or the third display 60 are fully extended from the first display 30.

C. Second Display

A second display 50 is provided that is movably attached to the first display 30 as shown in the attached figures. The first display 30 is preferably pivotally attached to the second display 50 as shown in FIGS. 1 through 3d of the drawings.

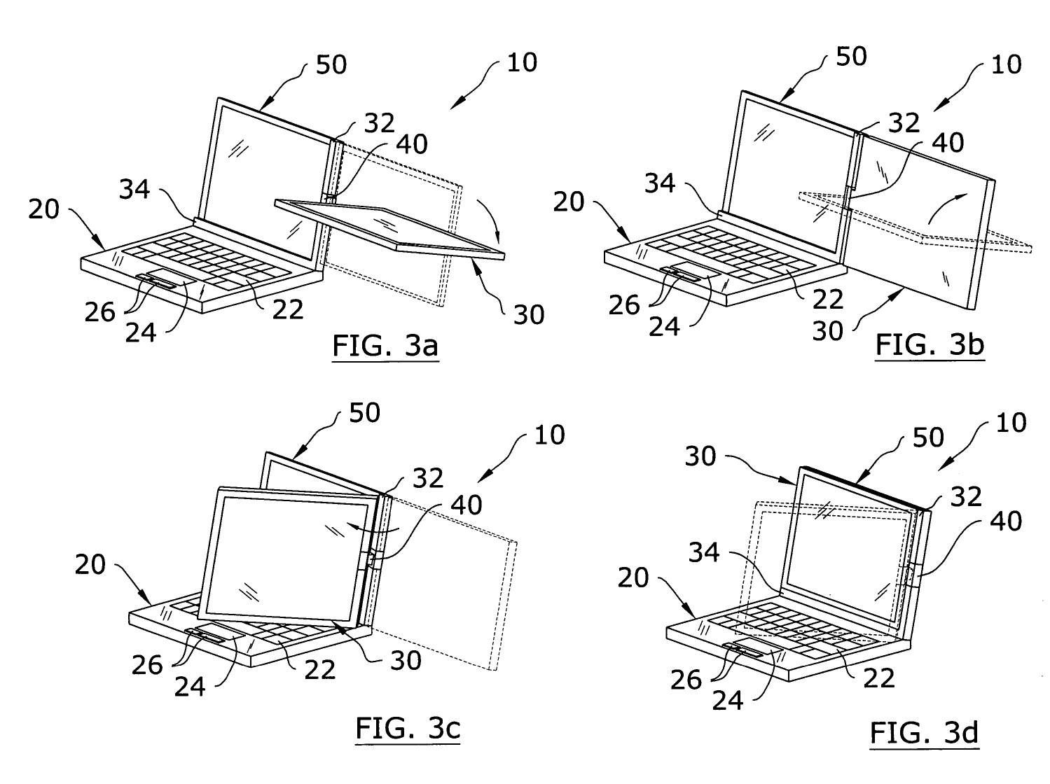

The first display 30 and the second display 50 are configured for allowing a user to view either the first display 30 by itself (FIG. 3d) or both the first display 30 and the second display 50 (FIG. 1). The second display 50 is preferably pivotally connected to the laptop 20 along a horizontal axis with the first display 30 pivotally connected to the second display 50 with a swivel hinge 40. The swivel hinge 40 allows the first display 30 to pivot along a horizontal axis and a vertical axis as illustrated in FIGS. 3a through 3d of the drawings. The swivel hinge 40 is preferably attached to a side of the first display 30 and the second display 50 as illustrated in FIGS. 1 through 3d of the drawings.

The first display 30 is positionable in an extended position (FIG. 1) thereby allowing viewing of both the first display 30 and the second display 50. The first display 30 is also positionable in a retracted position (FIG. 3d) substantially covering the second display 50 thereby allowing viewing of only the first display 30. It can be appreciated that the hardware and the software utilized on the laptop 20 should allow for the user to adjust the primary screen and other features commonly controlled in a multiple display environment.

A vertical member 32 preferably extends forwardly from a side (right or left) of the second display 50 supporting the first display 30 as illustrated in FIGS. 1 through 3d of the drawings. A horizontal member 34 preferably extends forwardly from a bottom edge of the second display 50 as also shown in the drawings. The horizontal member 34 may be positioned at the top edge of the second display 50 also. The vertical member 32 and the horizontal member 34 preferably each have a thickness approximately equal to a thickness of the first display 30 so to provide a solid appearance when the first display 30 is positioned in front of the second display 50 as shown in FIG. 3d of the drawings.

D. First Alternative Embodiment

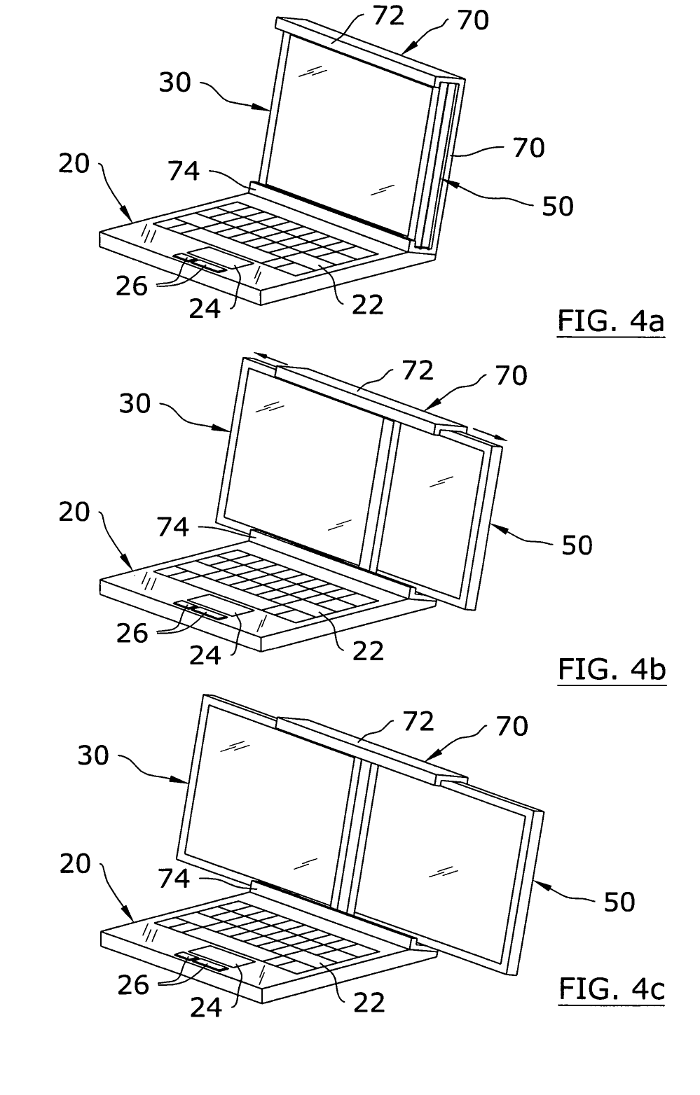

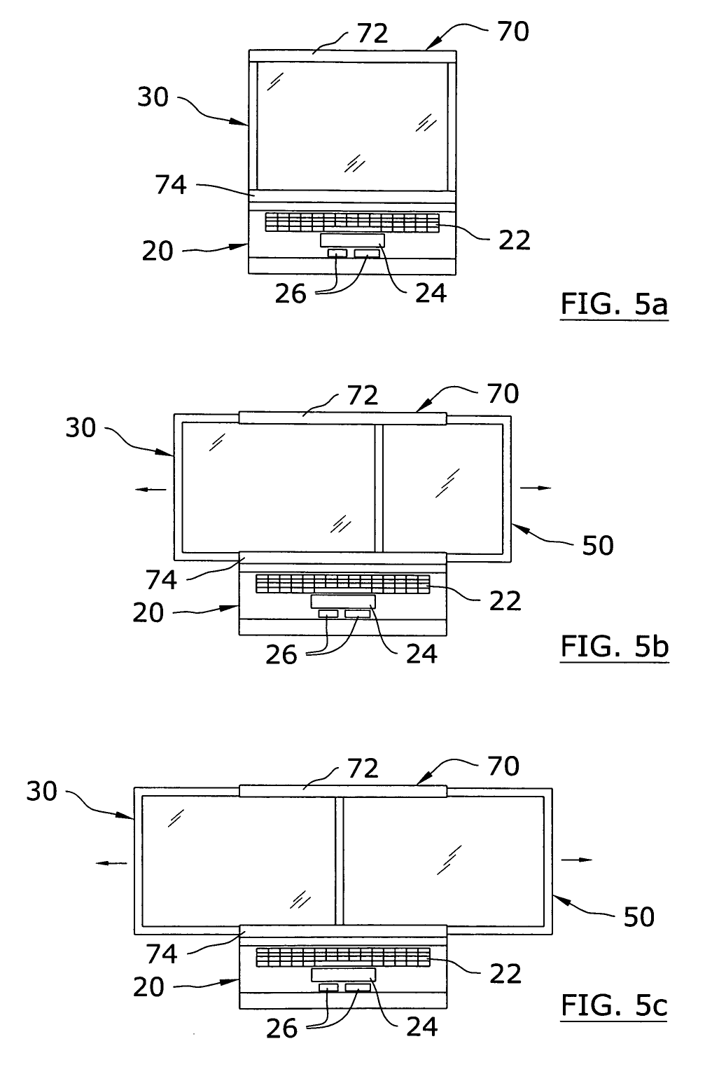

As shown in FIGS. 4a through 5c of the drawings, a rear support 70 is attached to the laptop 20 thereby slidably supporting the first display 30 and the second display 50. The first display 30 and the second display 50 move along a substantially horizontal axis opposite of one another as best illustrated in FIGS. 5b and 5c of the drawings.

The rear support 70 preferably includes an upper support 72 and a lower support 74 for slidably supporting the first display 30 and the second display 50. The upper support 72 and the lower support 74 preferably have a rail structure for slidably receiving the upper and lower portions respectively of the first display 30 and the second display 50. It is preferable that when the first display 30 and the second display 50 are full extended that their respective inner edges are substantially centered on the laptop 20 as illustrated in FIG. 5c of the drawings.

E. Second Alternative Embodiment

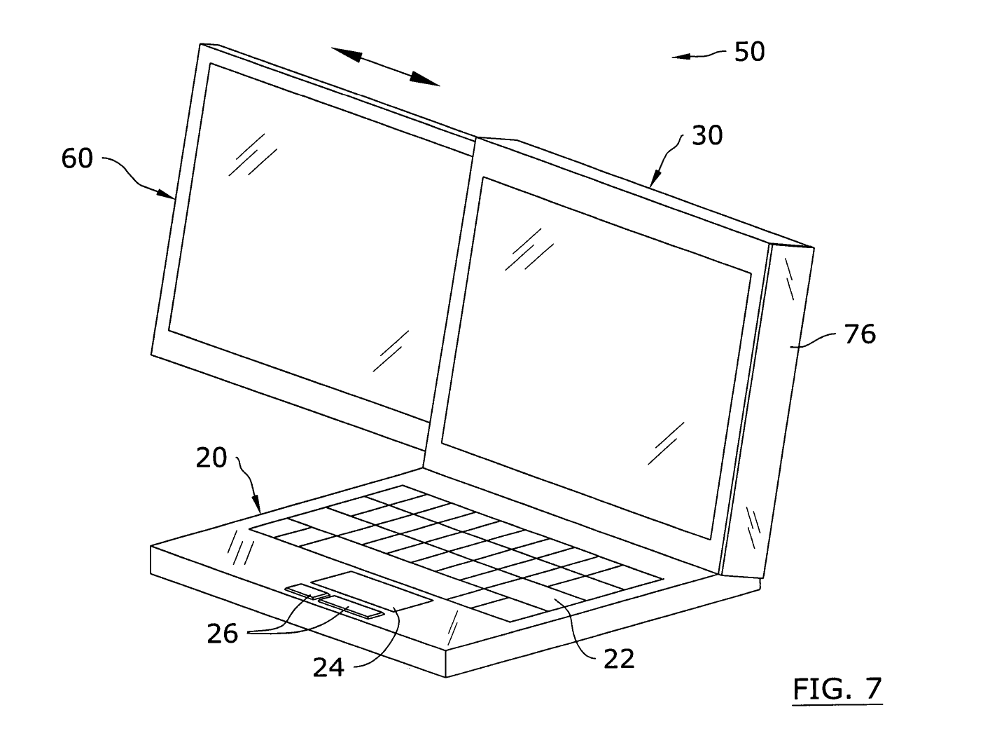

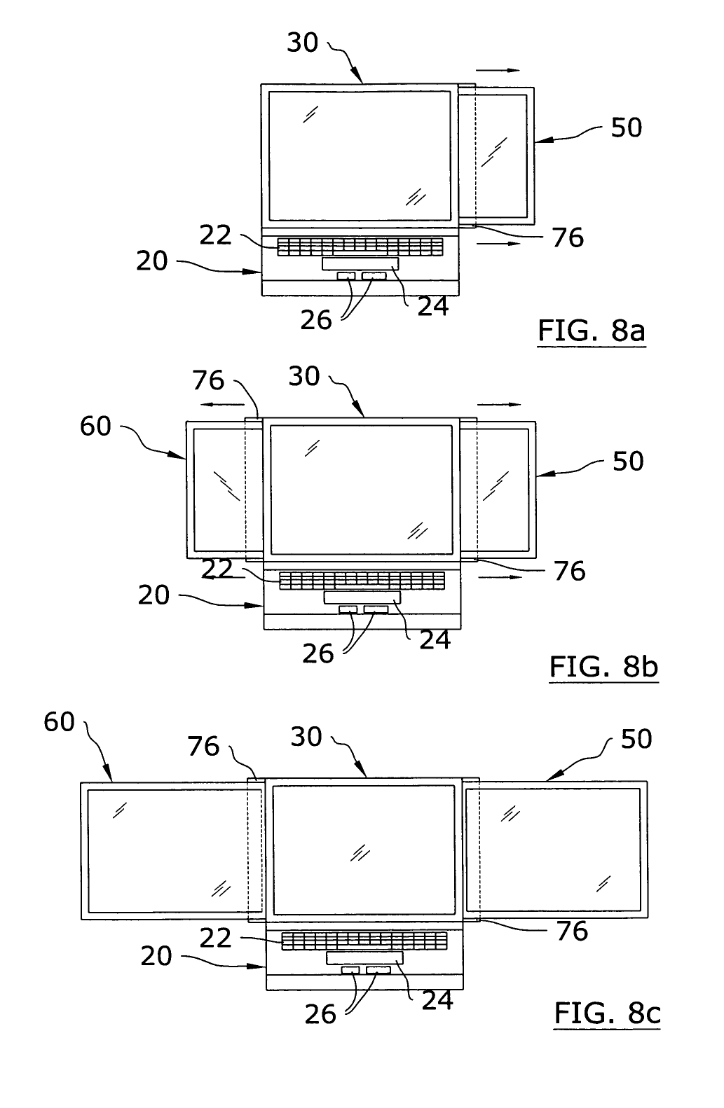

FIGS. 7 through 8c illustrate a second alternative embodiment where a second display 50 and a third display 60 are slidably received within a housing of the first display 30. A first side door 76 is movably attached to the first display 30 for covering a first side opening when the second display 50 is in a retracted position and a second side door 76 is movably attached to the first display 30 for covering a second side opening when a third display 60 is in a retracted position. The first side door 76 and the second side door 76 are preferably biased towards a closed position.

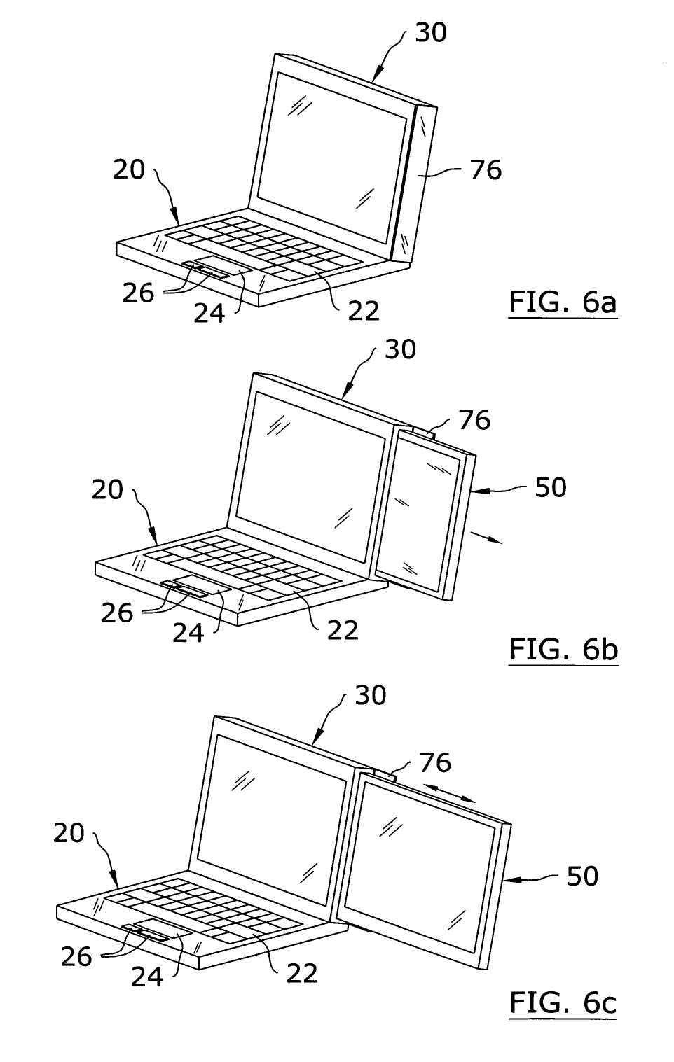

The first alternative embodiment (FIGS. 4a through 5c) and the second alternative embodiment (FIGS. 6a through 8c) may utilize a motorized drive system to extend and retract the displays 40, 50. The motorized drive system may be comprised of any conventional electrically powered drive system capable of extending the displays 40, 50 with respect to the first display 30.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention, which is intended to be defined by the following claims (and their equivalents) in which all terms are meant in their broadest reasonable sense unless otherwise indicated. Any headings utilized within the description are for convenience only and have no legal or limiting effect.

1. A multi-screen laptop system, comprising:
a laptop having a first display; and
a second display, wherein said first display and said second display are movably connected to one another.

2. The multi-screen laptop system of claim 1, wherein said first display is pivotally attached to the second display.

3. The multi-screen laptop system of claim 2, wherein said first display and said second display are configured for allowing a user to view either the first display by itself or both the first display and the second display

4. The multi-screen laptop system of claim 2, wherein said second display is pivotally connected to said laptop along a horizontal axis, and wherein said first display is pivotally connected to said second display with a swivel hinge.

5. The multi-screen laptop system of claim 4, wherein said swivel hinge allows said first display to pivot along a horizontal axis and a vertical axis.

6. The multi-screen laptop system of claim 4, wherein said first display is positionable in an extended position thereby allowing viewing of both said first display and said second display, and wherein said first display is positionable in a retracted position substantially covering said second display thereby allowing viewing of only said first display.

7. The multi-screen laptop system of claim 6, including a vertical member extending forwardly from a side of said second display supporting said first display, and a horizontal member extending forwardly from a bottom edge of said second display.

8. The multi-screen laptop system of claim 7, wherein said vertical member and said horizontal member have a thickness approximately equal to a thickness of said first display.

9. The multi-screen laptop system of claim 4, wherein said swivel hinge is attached to a side of said first display and said second display.

10. The multi-screen laptop system of claim 1, including a rear support attached to said laptop slidably supporting said first display and said second display.

11. The multi-screen laptop system of claim 10, wherein said first display and said second display move along a substantially horizontal axis.

12. The multi-screen laptop system of claim 10, wherein said rear support includes an upper support and a lower support for slidably supporting said first display and said second display.

13. The multi-screen laptop system of claim 1, wherein said second display is slidably positioned within a housing of said first display and extendable through a first side opening within said first display.

14. The multi-screen laptop system of claim 13, including a side door movably attached to said first display for covering said first side opening when said second display is in a retracted position.

15. The multi-screen laptop system of claim 13, including a third display slidably positioned within said housing of said first display and extendable through a second side opening opposite of said first side opening within said first display.

16. The multi-screen laptop system of claim 15, including a first side door movably attached to said first display for covering said first side opening when said second display is in a retracted position and a second side door movably attached to said first display for covering said second side opening when said third display is in a retracted position.

17. The multi-screen laptop system of claim 16, wherein said first side door and said second side door are biased towards a closed position.

18. The multi-screen laptop system of claim 15, wherein said first display, said second display and said third display are electrically connected to a video card within said laptop capable of providing a horizontal mode to said first display, said second display and said third display.

19. The multi-screen laptop system of claim 18, wherein said horizontal mode is entered into only if said second display and/or said third display are fully extended from said first display.
